(19) United States
(12) Patent Application Publication
(10) Pub. No.: US 2006/0090194 A1
(43) Pub. Date: Apr. 27, 2006

(54) Secure network management solution for Internet/computer equipment

(76) Inventor: Ernest Lewis Smiley, Montclair, VA (US)

Correspondence Address: Ernest Smiley, 16211 S. Edgewood Dr., Montclair, VA, 22026, US

(21) Appl. No.: 10/968,882

(22) Filed: Oct. 21, 2004

(51) Int. Cl. H04L 9/32

(52) U.S. Cl. 726/3

(57) ABSTRACT

A secure network management application utilizing an Internet Protocol (IP) and Secure Network Management Protocol System (SNMPS) for managing computers and IP Based equipment. Using the secure network management protocol and method, Internet/Computer equipment can easily implement security measures to control access to a Network Operation Center (NOC), Enterprise Security Management Center or other security management operations by communications secure and non-secure originating from IP Based equipment and computers but allow communications between the NOC and the Internet.

### BACKGROUND

Secure Network Management protocol enterprises must mitigate—risks inherent in the use of the Internet, telecommunications, wireless technologies, and other network management equipment. The need to increase the survivability of Network Management/Operations Centers during day-to-day operations and emergency recovery operations are paramount for government, military, commercial environments. Maintaining Enterprise Security Management services infrastructure demands a comprehensive security management approach, with enterprise security management a key enabler for operations services success.

Secured access to Enterprise Security Management services databases and information sharing processes requires a secure management platform. The platform ensures consistent application of security policies and infrastructure configurations; it ensures the consistent availability of these resources. The Enterprise Security Management (ESM) approach streamlines processes and forges new emergency provider relationships. It gives shared resources from the infrastructure (evolving networking and applications configuration Internet-based security protocol).

Computer networks have become commonplace in modern times. There are a variety of network management topologies and applications that permit network servers, terminals and peripheral devices (collectively, “components”) to interoperate and provide coordinated communications computer services. To support computer networks, firms often employ information technology technicians to monitor the state of the computer networks and maintain network components in an operable state.

To provide the technician with sufficient secure information to permit the technician to perform its function, individual network components may include “instrumentation entities” that can determine the component's operating condition.

### SUMMARY

According to an embodiment, the present invention may provide a secure network management protocol for a computer network. The secure network management protocol may include a secure network management agent having a database/library and a plurality of data sources distributed throughout the computer network. The secure network management protocol is provided in communication with the data sources via instrumentation entities of the components.

### DETAILED DESCRIPTION

Embodiments of the present invention provides a secure network management agent for a computer network. The secure network management agent receives alerts from a plurality of data sources, harmonizes the alerts and reports harmonized alerts to an application console. SNMPS permits like-kind alerts from different instrumentation entities to be presented to a technician using similar formats.

Embodiments of the present invention provide a secure network management agent for a computer network. The secure network management agent receives alerts from a plurality of data sources, harmonizes the alerts and reports harmonized alerts to an application console.

FIG. 1 illustrates secure network management communications between TCP/IP, SNMP and SNMPS. This illustration provides a platform for communications between computer equipment, network devices and interfaces to telecommunications.

FIG. 2 provides an illustration of current SNMP technology communicating with SNMPS over an IP network. This process an integrate platform for current (HP Openview, E-Trust, Firewalls, and VPN) technology and processes to communicate with SNMPS platform

### BRIEF DESCRIPTION OF THE DRAWINGS

FIG. 1 is a block diagram of an exemplary of secure management protocol communicating with SNMP, TCP/IP and the Internet with an embodiment of the present invention.

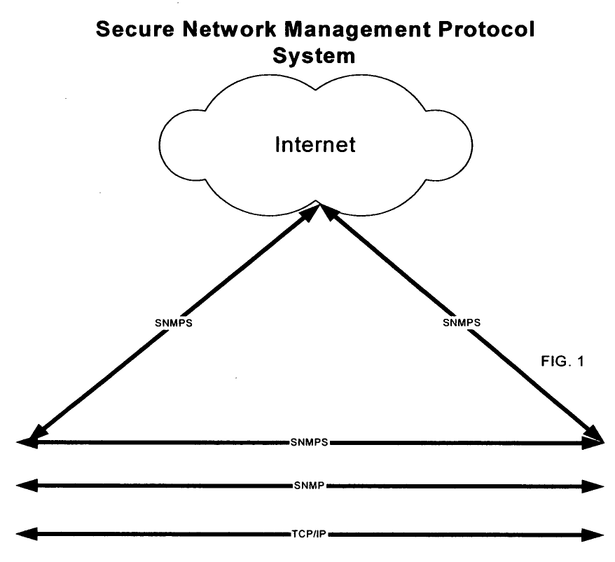

FIG. 2 is a block diagram of a secure network management protocol system communicating with TCP/IP network and new technology constructed in accordance with an embodiment of the present invention.

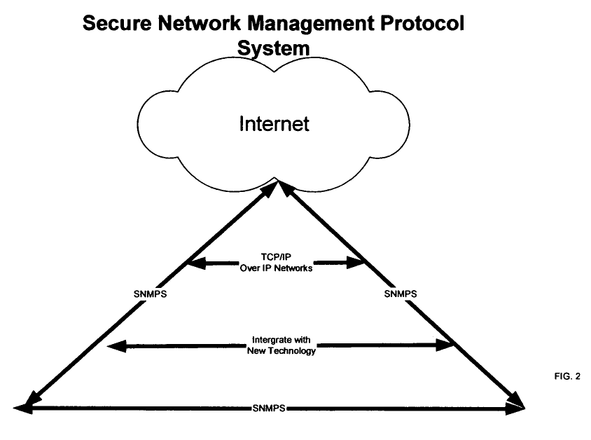

FIG. 3 is an illustration of current technology (HP Openview, E-Trust, Firewalls, and VPN) software layers of a secure network management agent in accordance with an embodiment of the present invention.

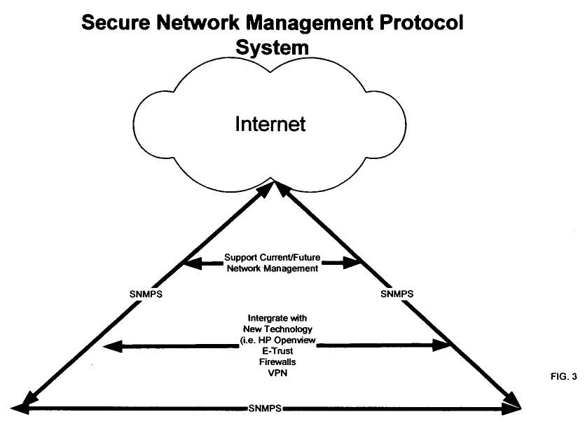

I claim:

1. A secure network management application, comprising:
a secure network management agent/protocol having a communications process, and
a plurality of data sources distributed among components of a computer network, wherein the secure network management agent is provided in communication with the data sources via different instrumentation entities of the components and wherein the communication process includes a secure network management protocol table to harmonize alerts received from each of the different SNMPS and Simple Network Management Protocol (SNMP) entities.

2. The SNMPS claim 1, wherein the secure network management protocol is distributed among components of the computer network.

3. The SNMPS of claim 2, communicates with the components/equipment includes data tables only for the secure protocol instrumentation entity on the one component.

4. The SNMPS of claim 3, wherein the secure network management agent is resident on a single component of the computer network (i.e. .com, .gov, .mil).

5. The SNMPS of claim 4, further comprising an application console in communication with the secure and non-secure network management agents and protocols.

6. The SNMPS of claim 5, wherein the communications table is for a desktop management interface instrumentation entity.

7. The secure network management application of claim 6, wherein the communications table is for a Secure Network Management Protocol System (SNMPS) and SNMP instrumentation entity.

8. The SNMPS system of claim 7, wherein the communications table is for an operating system instrumentation entity.

9. A SNMPS, comprising:
a secure network management application having a polling database, and
a plurality of data sources distributed among components of a computer network, wherein the secure network management protocol is provided in communication with the data sources via different instrumentation entities of the components and wherein the polling database includes definitions of polling parameters to poll the plurality of different instrumentation entities and the polling library further includes tables for the instrumentation entities to harmonize alerts received responsive to the polls.

10. The SNMPS of claim 8, wherein the secure network management agent itself is distributed among components of the computer network.

11. The SNMPS of claim 9, wherein the secure network management agent is resident on a single component of the computer network.

12. The SNMPS of claim 10, further comprising an application console in communication with the secure network management agent.

13. A method of processing instrumentation entity events, comprising
receiving data representing an event from a plurality of different instrumentation entities, wherein the event indicates a network component's operating condition,
harmonizing the events received from the plurality of different instrumentation entities using a library, and outputting alerts representative of the harmonized events, wherein the alerts are outputted using similar formats.
